(19) United States
(12) Patent Application Publication
(10) Pub. No.: US 2014/0174246 A1
(43) Pub. Date: Jun. 26, 2014

(54) HANDLEBAR

(71) Applicant: TIEN HSIN INDUSTRIES CO., LTD., TAICHUNG CITY 41353 (TW)

(72) Inventor: YOU-RONG CHIANG, TAICHUNG CITY 41353 (TW)

(73) Assignee: TIEN HSIN INDUSTRIES CO., LTD., TAICHUNG CITY 41353 (TW)

(21) Appl. No.: 13/870,121

(22) Filed: Apr. 25, 2013

(30) Foreign Application Priority Data
Dec. 21, 2012 (TW) 101224866

(51) Int. Cl. B62K 21/12

(52) U.S. Cl. CPC B62K 21/12
USPC 74/551.1

(57) ABSTRACT

A handlebar includes a main body and two grip portions. The main body includes at least one extending portion extended away from the main body, and at least one through hole opened on the extending portion. The two grip portions are formed at opposite ends of the main body. The advantage of the handlebar is to omit the stem that can lighten the weight and reduce the wind resistance to make the riders safer and comfortable riding.

### BACKGROUND OF THE INVENTION

1. Field of the Invention

The present invention relates to a handlebar, and more particularly, to a handlebar which is directly assembled to a front fork of a bicycle without the application of a stem.

2. Description of Related Art

Bicycle downhill race is a popular activity for many cyclers. Racers ride on the mountain road or wild road which is unsmooth and bumpy so as to compete with each other.

Referring to FIG. 1, a conventional handlebar set for a bicycle is made of carbon fiber. The conventional handlebar set for a bicycle includes a handle portion. A middle part of the handle portion has a stem portion extended therefrom. One end of the stem portion has a stem hole opened thereon so as to assemble with a fork portion of a bicycle. The handle portion has two grip portions extended therefrom for the rider to grip on. Under this arrangement, the weight of the conventional handlebar set for a bicycle is greatly reduced and still provides enough structural strength for the rider.

However, since the circumstance for the race is so tough, during the race, the conventional handlebar set for a bicycle is breakable easily from a connection between the handle portion and the stem portion. As a result, the conventional handlebar set for a bicycle is not applicable for joining the downhill races.

The present invention has arisen to mitigate and/or obviate the disadvantages of the conventional.

### SUMMARY OF THE INVENTION

The main objective of the present invention is to provide a handlebar, which omit the stem to reduce weight and enhance strength.

To achieve the objective, a handlebar which is connected to a front fork directly via at least one fastener includes a main body and two grip portions. The main body has at least one extending portion extended therefrom, and at least one through hole is opened on the extending portion. Furthermore, the two grip portions are formed at two opposite ends of the main body. The main body has at least one first recess formed at a bottom surface thereof, and each extending portion has at least one second recess formed at a bottom surface thereof. The handlebar has an inclined surface formed thereon the main body toward the extending portion, and the inclined surface is descending from the main body toward the extending portion. Each grip portion has at least one third recess and the at least one third recess extends away from the main body. The two grip portions and the main body are formed integrally as a whole.

Under this arrangement, each fastener passes each corresponding through hole to be secured on the front fork, so that the main body is fastened on the front fork.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a conventional handlebar set for a bicycle;

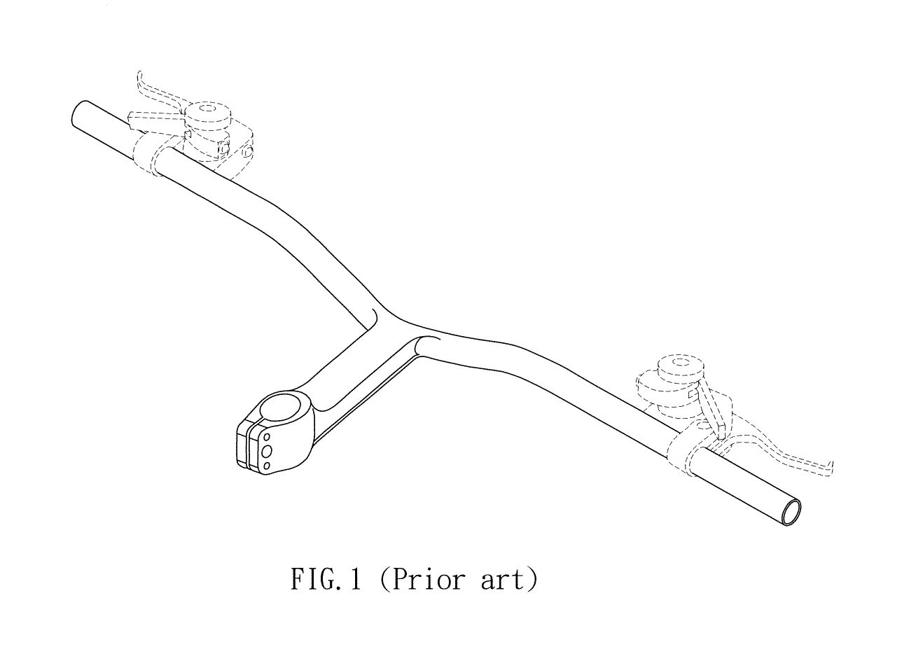

FIG. 2 is a top plan view of a handlebar according to a first embodiment of the present invention;

FIG. 3 is a bottom plan view of the handlebar according the first embodiment of the present invention;

FIG. 4 is a side view of the handlebar according first embodiment of the present invention;

FIG. 5 is a perspective view for showing the handlebar of the first embodiment being assembled to a front fork of a bicycle; and

FIG. 6 is a perspective view for showing a handlebar of a second embodiment of the present invention, in which the main body has at least one extending portion extruded therefrom, and at least one first recess and at least one second recess defined thereon.

### DETAILED DESCRIPTION OF THE INVENTION

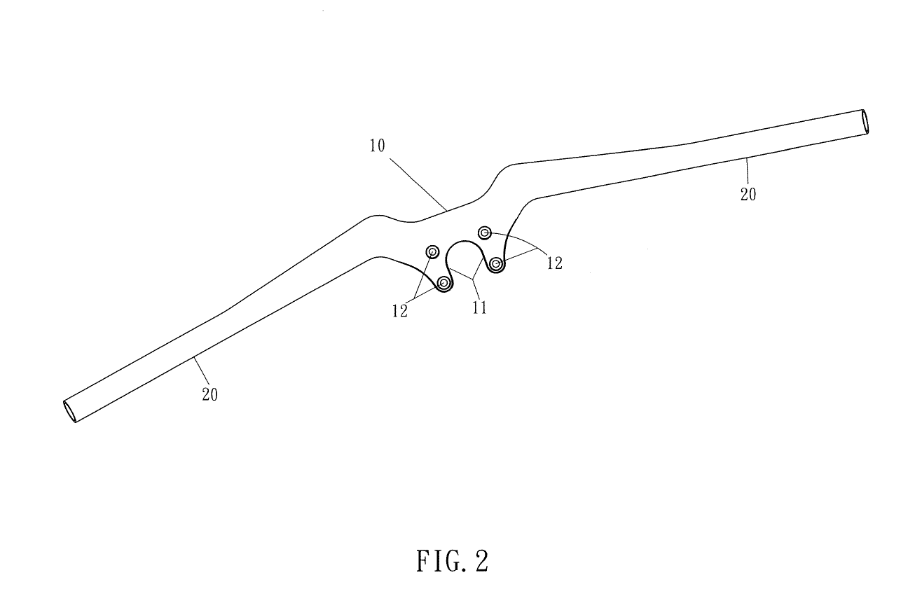

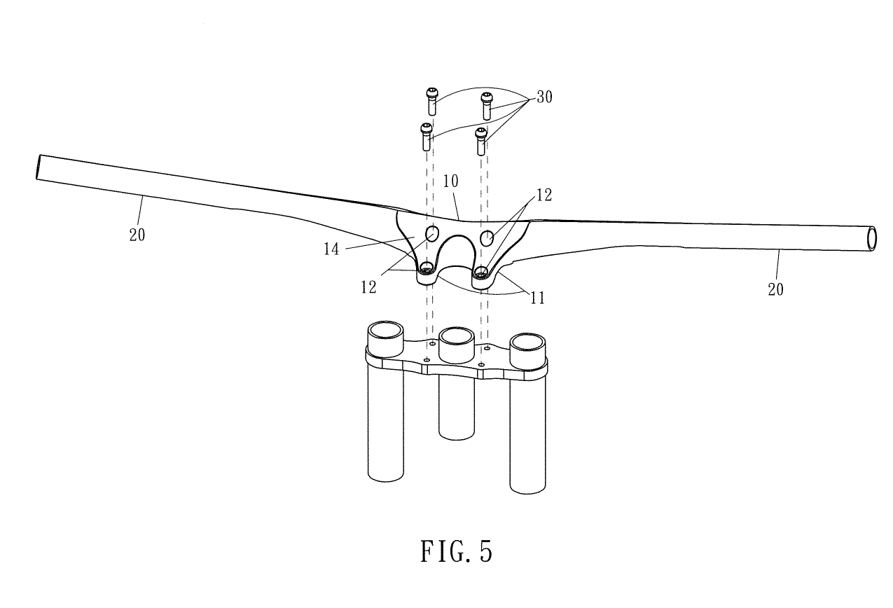

Referring to FIGS. 2-5, a handlebar of a first embodiment of the present invention is connected to a front fork (not numbered) via four fasteners 30. As shown in FIG. 2, the handlebar includes a main body 10 and two grip portions 20. The main body 10 has an extending portion 11 extended therefrom, as shown in FIG. 2, the main body 10 has two extending portions 11 extended therefrom. Four through holes 12 are opened on the two extending portions 11. The two grip portions 20 are formed at two opposite ends of the main body 10, that is, the two grip portions 20 and the main body 10 are formed integrally as a whole. The two grip portions 20 are formed adjacent to the surface where the extending portions 11 extended from. As shown in FIG. 5, each fastener 30 passes each corresponding through hole 12 to be secured on the front fork, so that the main body 10 is fastened on the front fork.

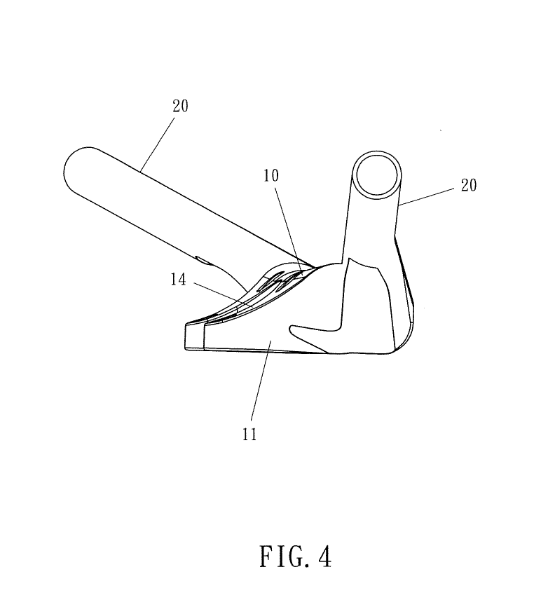

Referring to FIG. 4, the handlebar further has an inclined surface 14 descended from the main body 10 toward the extending portions 11 so as to reduce the weight of the handlebar and to provide enough structural strength of the main body 10 to bear the weight of the rider.

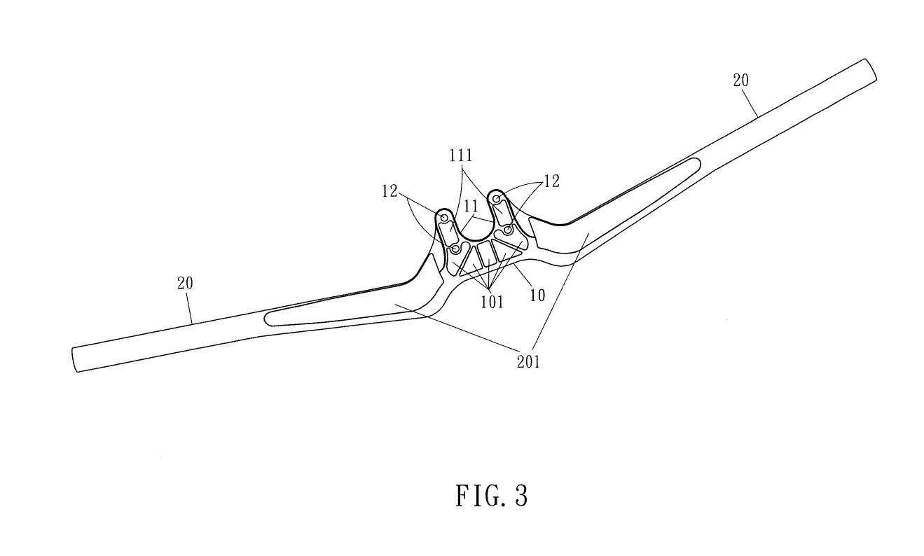

In the first preferred embodiment, as shown in FIG. 3, the main body 10 has five first recesses 101 formed at a bottom surface thereof, each extending portion 11 has a second recess 111 formed at a bottom surface thereof and each grip portion 20 has one third recess 201. The third recesses 201 extend away from the main body 10.

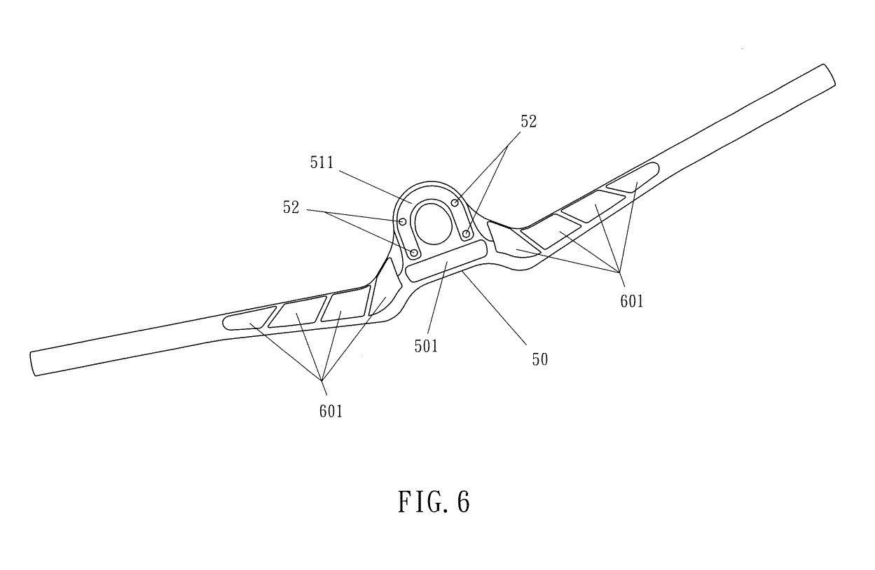

Finally, please refer to FIG. 6 of a handlebar according to a second preferred embodiment of the present invention.

The main body 50 of the second preferred embodiment has a first recess 501 and a second recess 511 formed thereon. Under this arrangement, the weight of the handlebar is reduced significantly because of said recesses 501, 511, 601.

The handlebar of the present invention has following advantages.

Firstly, because the stem (not shown) is omitted, the weight of an upper half of the rider is directly bore by the fork, thus, the present invention can effectively prevent a rider from been hurt by a braking stem.

Secondly, the weight of the handlebar is reduced significantly because of the recesses 101, 111, 201 and the inclined surface 14, while the handlebar still provides enough structural strength so that the rider rides on a mountain road stably and safely.

Although the invention has been explained in relation to its preferred embodiments, it is to be understood that many other possible modifications and variations can be made without departing from the spirit and scope of the invention as hereinafter claimed.

What is claimed is:

1. A handlebar which is assembled to a front fork via at least one fastener comprising:
a main body and two grip portions, the main body having at least one extending portion extended therefrom, at least one through hole being opened on the extending portion; and
the two grip portions being formed at two opposite ends of the main body;
wherein, the fastener passes the through hole to be secured on the front fork, so that the main body is fastened on the front fork.

2. The handlebar as claimed in claim 1, wherein the main body has at least one first recess formed at a bottom surface thereof.

3. The handlebar as claimed in claim 1, wherein each extending portion has at least one second recess formed at a bottom surface thereof.

4. The handlebar as claimed in claim 1, wherein the handlebar has an inclined surface formed thereon the main body toward the extending portion, the inclined surface is descending from the main body toward the extending portion.

5. The handlebar as claimed in claim 1, wherein each grip portion has at least one third recess, the at least one third recess extends away from the main body.

6. The handlebar as claimed in claim 1, wherein the two grip portions and the main body are formed integrally as a whole.
